(19) United States
(12) Patent Application Publication
(10) Pub. No.: US 2026/0062230 A1
(43) Pub. Date: Mar. 5, 2026

(54) DEVICE AND METHOD FOR TRANSFERRING BLANKS

(71) Applicant: OPTIMA life science GmbH, Schwäbisch Hall (DE)

(72) Inventors: Michael Lutz, Schwäbisch Hall (DE); Johannes Jansen, Schwäbisch Hall (DE)

(73) Assignee: OPTIMA life science GmbH, Schwäbisch Hall (DE)

(21) Appl. No.: 19/291,254

(22) Filed: Aug. 5, 2025

(30) Foreign Application Priority Data
Sep. 3, 2024 (DE) 102024125067.4

(51) Int. Cl. B65G 47/08; B65G 17/32; B65G 47/84

(52) U.S. Cl. CPC B65G 47/08; B65G 17/323; B65G 47/848; B65G 2203/0225; B65G 2203/0233; B65G 2811/095

(57) ABSTRACT

The invention relates to a device and a method for transferring blanks to a transfer line, in particular for transferring blanks (10) to a material track, a transport track (14), a rotating roller and/or to products (12) transported along a conveyor belt, the device (1) comprising a positioning system (2) with at least two, in particular three or more, carriages (20) movable along a circumferential track and with a drive system (24), wherein the carriages (20) each have a product holder (22) and are designed to pick up one blank (10) at a time on the product holder (22), transport the blank (10) in a fixed position on the product holder, and transfer the blank (10) to the transfer line, and wherein the drive system (24) is designed to move the carriages (20) along the circumferential track at least in sections independently of one another.

### CROSS-REFERENCE TO RELATED APPLICATION

The present application claims priority to German Patent Application No. 102024125067.4, filed Sep. 3, 2024, the entirety of which is incorporated herein by reference.

### FIELD OF APPLICATION AND PRIOR ART

The invention relates to a device and method for transferring blanks to a transfer line. The invention relates in particular to a device and a method for transferring blanks to a material track, a transport track, a rotating roller, and/or to products transported along a conveyor belt.

It is known that products such as, but not limited to, membrane electrode assemblies (MEA) or parts thereof for fuel cells, electrolysis cells or redox flow cells (liquid batteries), membrane-based air humidifiers or products for wound care or transdermal therapeutic systems, are manufactured and/or processed from material tracks. Products manufactured and/or processed from material tracks are also referred to here as products manufactured nd/or processed in the track.

For various applications, products manufactured and/or processed on the track must be provided with blanks, wherein the blanks are, for example, produced rotatively in a further material track and deposited on a material track referred to as the main track. It is also known to deposit blanks made from material tracks or blanks from a supply on a transport track for further transport and/or to deposit them on products transported along a conveyor belt, for example for labeling and/or for forming a laminate along the conveyor belt.

Vacuum rollers, also known as vacuum cylinders, are commonly used to transfer the blanks to a transfer line. Vacuum rollers are rollers that have a porous or perforated surface on their mantle surface, through which vacuum is applied.

For example, DE102007016426 A1 shows a method and device for labeling objects such as bottles or other packaging containers, wherein labels are punched out of a printed label strip made of paper or film material in a roller gap between two rotating rollers, the punched-out labels are sucked against a first roller designed as a vacuum roller and are carried along by this first roller, and by means of this first roller or an additional vacuum roller, to which the objects to be labeled are transferred.

WO 99/62801 A2 describes a device for transferring multi-layer blanks to a main track, comprising a first vacuum cutting roller and a first counter roller for producing blanks from a first material track, and a vacuum transfer roller for taking over the blanks from the first vacuum cutting roller and transferring the blanks to the main track, wherein a transport speed of the main track is higher than a transport speed of the first vacuum cutting roller and the vacuum transfer roller rotates at a variable speed in order to take over the blanks from the first vacuum cutting roller at a speed corresponding to the transport speed of the vacuum cutting roller and to transfer the blanks to the main track at a speed corresponding to the transport speed of the main track.

It is also known to produce blanks on a vacuum roller by means of a cutting roller, which are transferred from the vacuum roller to a vacuum transfer roller and deposited by the vacuum transfer roller on a main track. In order to bring the blanks to a distance at which they are to be deposited on the main track, in particular to increase the distance between the blanks, it is known to provide a transfer from a slowly rotating vacuum roller to a faster rotating vacuum transfer roller and/or to temporarily reduce the speed of the vacuum roller during transfer from the vacuum roller to the vacuum transfer roller.

It is also known to measure the blanks placed on the main track using a sensor system or an imaging system, to determine position deviations, and to transmit these determined position deviations to a control system for position correction of subsequent placement operations.

When transferring from the vacuum roller to the vacuum transfer roller, which rotates at least temporarily faster, slippage effects can occur, which impair the positional accuracy of the blanks on the main track by shifting or twisting them. In order to largely compensate for uncontrollable slip effects that lead to statistical position deviations, it is known to use a so-called trend control for position correction of subsequent depositing processes, wherein a number of blanks are measured and their position deviations are averaged. When the machine starts up after a restart or after sudden changes, such as those that occur when there is a misalignment in a splice region of one of the processed or machined material tracks, this can lead to undesirable amounts of scrap.

### PROBLEM AND SOLUTION

The invention aims to provide a device and a method for transferring blanks, which enable the blanks to be transferred to a transfer line as accurately as possible and/or without slipping.

This task is solved by a device according to claim 1 and a method according to claim 10. Advantageous designs are shown in the sub-claims.

According to a first aspect, a device is provided for transferring blanks to a transfer line, in particular for transferring blanks to a material track, a transport track, a rotating roller, and/or to products transported along a conveyor belt, the device comprising a positioning system with at least two, in particular three or more, movable carriages along a circular track, in particular along a circumferential track, and a drive system, wherein the carriages each have a product holder and are designed to each pick up a blank at the product holder, transport the blank in a fixed position at the product holder, and to transfer the blank to the transfer line, and wherein the drive system is designed to move the carriages along the circumferential track at least in sections independently of one another.

According to a second aspect, a method is provided for transferring blanks to a transfer line, in particular for transferring blanks to a material track, a transport track, a roller, and/or to products transported along a conveyor belt, comprising providing a positioning system with at least two, in particular three or more, carriages movable along a circumferential track, each having a product holder, and picking up, transporting, and transferring the blanks with the carriages of the positioning system having the product holders, wherein the carriages are moved independently of one another along the circumferential track, at least in sections.

The positioning system replaces a conventional vacuum transfer roller used for transfer.

The independent movement of the carriages allows the movement of the carriages to be synchronized with the speed of a device that provides the blanks for the positioning system when the blanks are picked up or transferred, ensuring slip-free transfer. The supplying device is usually a rotating roller, in particular a vacuum roller. However, due to the independent movement of the carriages, it is also conceivable to transfer the blanks from a stationary supply.

The independent movement of the carriages also allows the carriages to be synchronized with the transfer line speed when transferring the blanks to the transfer line.

The device and method are therefore particularly suitable for the precise and distortion-free transfer of blanks made from sensitive materials with high cycle times.

In embodiments, the drive system is set up to individually adjust the speed of the assigned carriage and/or the position of the assigned carriage along the circumferential track for picking up and/or transferring each blank.

The independent movement of the carriages allows individual adjustment for each blank. This makes it possible to individually adjust the transfer time of each blank and thus the position of the blank on the transfer line. The option of individual customization allows errors to be avoided in advance. Individual adjustment also allows adaptation to sudden deviations, for example in a splice region of a material track. This can prevent unwanted amounts of scrap, especially when starting up a production plant.

In one embodiment, a sensor system is provided which is set up to detect a position and/or orientation of the blanks on the respective product holder. The sensor system is configured to detect the position of the blank relative to a direction of movement along the circumferential track. In further embodiments, the sensor system is further configured to detect a position transverse to the direction of movement of the circumferential track and/or an orientation of the blank.

For any necessary correction of the position and/or orientation of the blank before it is transferred to the transfer line, the carriages in the embodiments each have an adjustment system which is designed to move the respective product holder before or during transfer to the transfer line transversely to a direction of movement along the circumferential track and/or to rotate it about a normal axis, i.e., the vertical axis, relative to the direction of movement. The adjustment system can be designed by a specialist to suit the specific application. In certain designs, the product holders are equipped with compact linear and/or rotary piezoelectric actuators, which enable maximum precision in the nanometer range. However, other adjustment systems are also conceivable.

The product holders are designed to hold the blanks securely in place, depending on the material being processed. In certain designs, items are held in place by electrostatic adhesion. Alternatively or additionally, the product holders in designs for stationary holding of the blanks on the product holders each comprise a porous and/or perforated suction surface which is connected to a vacuum source.

The design provides for the carriages to move along a circumferential track designed as a circular track around a central axis.

For individual movement of the carriages, the drive system is designed as a linear motor system, with the carriages each attached to a runner of the linear motor system. A circumferential track can be implemented in any shape suitable for the respective application.

In other embodiments, the drive system comprises several motors, in particular electric motors, and more specifically servo motors, each of which is assigned to a carriage. In some designs, the motors are specifically designed as coaxially arranged torque motors, with the carriages attached to the rotors of the torque motors. A torque motor is a high-pole electric direct drive. Depending on the application, the torque motors are designed as external rotor torque motors with an external rotor ring or as internal rotor motors with an internal rotor ring. The circumferential track along which the carriages move is a circular track. The torque motors are arranged one behind the other in a longitudinal direction on a mounting rail. The carriages are each attached to the rotor via a suitable pivot arm, wherein the shape of the pivot arms is designed such that the carriages are moved in a common lane along the circular track.

In one embodiment, a media channel is provided within the circumferential track, in particular coaxially with the central axis of the circumferential track designed as a circular track. The media carried in the media channel are, in particular, media such as electricity, data signals, compressed air, vacuum, or the like, which are necessary for moving the carriages and/or the product holders and/or holding the blanks on the product holders. In particular, designs are provided in which the carriages and/or elements of the drive system are connected to the media channel for media transfer by means of a slip ring arrangement.

In particular, in designs for supplying the carriages with vacuum and/or compressed air (positive pressure), it is provided that a mounting rail, on which in particular torque motors for driving the carriages are arranged, has regions in which cylindrical chambers enclose the mounting rail and are fixedly attached to it. The cylindrical chambers are supplied with vacuum or positive pressure. On the outer sides of the cylindrical chambers, there is a sealing sliding surface that surrounds the transfer body, which is firmly connected to the carriages and/or the pivot arms. The transfer body is designed in particular as a torus and/or as a toroidal channel with a rectangular cross-section. Vacuum or positive pressure enters the transfer body through openings in the sealing sliding surface and the inner side of the transfer body facing the sliding surface. Channels allow vacuum or positive pressure to be transferred from the transfer body to the product holders and/or actuators of the carriage. The holes in the cylindrical chamber and on the inside of the transfer body are arranged, depending on the application, so that the carriages are supplied over the entire range (360°) or only over a limited angular range, in particular an angular range that is important, for example, for supplying vacuum to the product holders.

In some designs, a vacuum roller is provided, wherein the positioning system and the vacuum roller form a transfer gap and are arranged to transfer blanks from the vacuum roller to the positioning system in the region of the transfer gap. For safe transfer, the vacuum roller has a pivot joint that can be adjusted relative to the direction of rotation of the vacuum roller, via which a vacuum can be created on a mantle surface of the vacuum roller.

In order to transfer a blank from the vacuum roller to the positioning system, the pivot joint is designed to pivot in the opposite direction to the rotation of the vacuum roller, thereby reducing or interrupting the vacuum in the region of the transfer gap and releasing the blank from the vacuum roller. In particular, further embodiments provide that the pivot joint is pivoted back to its initial position after transfer with the vacuum roller so that a subsequent blank is reliably guided to the transfer gap.

In designs with a cutting roller, the vacuum roller forms a cutting gap, wherein cuts are made in a fed material track by means of the cutting roller in order to produce the blanks. The cutting roller is arranged in particular above the vacuum roller. In other designs, the vacuum roller is designed as a vacuum cutting roller, wherein the vacuum cutting roller interacts with a counter-punching cylinder. The vacuum cutting roller is arranged in particular below the counter-punching cylinder. In yet other designs, a carrier track with blanks arranged thereon is fed to the vacuum roller, wherein the carrier track is delaminated from the blanks on the vacuum roller. The invention is not limited to these designs, and other designs are conceivable in which blanks are supplied to the positioning system by means of a vacuum roller.

### BRIEF DESCRIPTION OF THE DRAWINGS

Further advantages and aspects of the invention are apparent from the claims and from the description of exemplary embodiments of the invention, which are explained below with reference to the figures. The following are shown:

FIG. 1 shows an exemplary embodiment of a device for transferring blanks comprising a positioning system, and

FIG. 2 shows a positioning system similar to FIG. 1 in a sectional view.

### DETAILED DESCRIPTION OF THE EXEMPLARY EMBODIMENTS

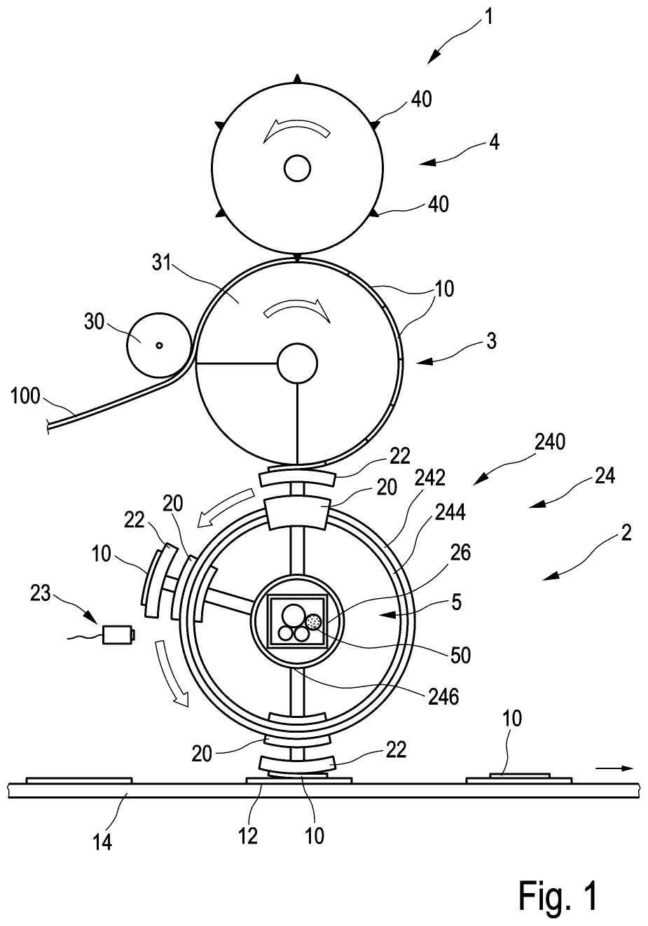

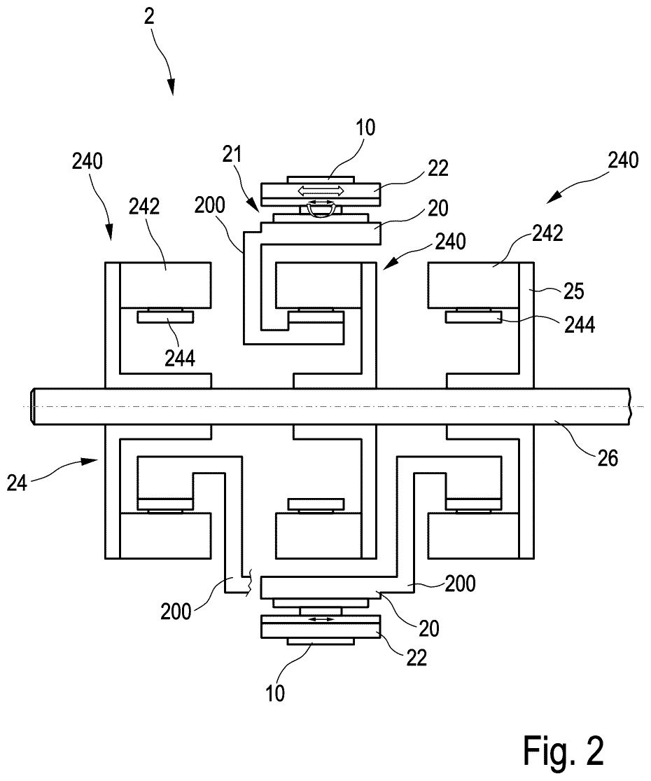

FIG. 1 schematically shows an exemplary embodiment of a device 1 for transferring blanks 10 to a transfer line comprising a positioning system 2. FIG. 2 schematically shows a positioning system 2 similar to FIG. 1 in a sectional view. Identical reference symbols are used in the drawings for identical or similar components or elements.

In the application shown in FIG. 1, the device 1 is used to transfer the blanks 10 to products 12 transported along a conveyor belt, which are transported by means of a transport track 14. However, the application shown is only an example, and in alternative designs, the blanks are placed, for example, directly on the transport track 14 or indirectly or directly on a material track (not shown) for a product manufactured on the track, or indirectly or directly on a rotating roller (not shown).

The device 1 comprises the positioning system 2, a vacuum roller 3 arranged above the positioning system 2, and a cutting roller 4 arranged above the vacuum roller 3.

The blanks 10 are transferred from the vacuum roller 3 to the positioning system 2 and from the positioning system 2 to a transfer line, in the exemplary embodiment shown to the products 12 transported along the conveyor belt.

The device 1 shown in FIG. 1 further comprises the cutting roller 4. The blanks 10 are produced from a material track 100 by means of the vacuum roller 3 and the cutting roller 4. The material track 100 from which the blanks 10 are produced is applied to the vacuum roller 3 in the exemplary embodiment shown by means of a pressure roller 30. The cutting roller 4 comprises several cutting edges 40, also referred to as knives, which separate the material track 100 guided through a cutting gap between the vacuum roller 3 and the cutting roller 4 into blanks 10. The vacuum roller 3 and the cutting roller 4 rotate in opposite directions. In the exemplary embodiment shown, the vacuum roller 3 rotates clockwise. However, the direction of rotation shown is only an example.

The vacuum roller 3 has a porous or perforated surface on its mantle surface and thus has openings through which vacuum is provided. The vacuum roller 3 and/or the cutting roller 4 are designed, especially in embodiments with a perforated surface, such that the cutting edges 40 do not come into contact with openings on the mantle surface of the vacuum roller 3. This ensures precise cutting.

In order to keep the amount of waste produced when creating the blanks 10 to a minimum, the blanks 10 are produced in particular in such a way that the blanks 10 are lined up seamlessly on the vacuum roller 3, as shown schematically in FIG. 1, or are only slightly spaced apart. In order to transfer the blanks 10 to the transfer line, it is particularly intended to create a distance between the blanks 10 or to change an existing distance, in particular to increase it.

For this purpose, the positioning system 2 comprises at least two, in the exemplary embodiment shown three, carriages 20, each with a product holder 22 and a drive system 24 for at least partially independent movement of the carriages 20 along a circumferential track, in the exemplary embodiment shown along a circular track. In the exemplary embodiment, the movement of the carriages 20 is counterclockwise, as shown schematically by arrows, wherein the products 12 are transported along the conveyor belt from left to right, as shown schematically by an arrow in the figure. However, the directions of movement shown are only examples.

The carriages 20 with the product holders 22 are each designed to take a blank 10 from the vacuum roller 3, hold the blank 10 taken over stationary at the product holder 22 for transport, and release the blank 10 for transfer to the transfer line. The product holders 22 are designed for this purpose and have a porous and/or perforated suction surface which is connected to a vacuum source (not shown).

The drive system 24 shown is set up to move the carriages 20 independently of each other, at least in sections.

The drive system 24 is specially designed to synchronize the carriages 20 with their product holders 22 with the circumferential speed of the blanks 10 on the vacuum roller 3 when picking up the blanks 10 from the vacuum roller 3, so that a slip-free transfer can take place. To ensure safe transfer and secure fixation of the blanks 10 on the product holders 22, the product holders 22 are equipped with suction surfaces as described above.

In the exemplary embodiment shown, the vacuum roller 3 has a schematically represented pivot joint 31 for reliable transfer of the blanks 10 to the carriages 20, via which a vacuum is provided on the mantle surface of the vacuum roller 3. The pivot joint 31 of the vacuum roller 3 extends—compared to a clock—over a region from approximately 9 o'clock to 12 o'clock to approximately 6 o'clock. If the pivot joint 31 is pivoted against the direction of rotation of the vacuum roller 3, in the exemplary embodiment shown counterclockwise by, for example, an angular range between approx. 3 minutes and approx. 15 minutes, for example approx. ten minutes, the blank 10 lying in this region is released from the vacuum roller 3. An angular range around which the pivot joint 31 is moved can be suitably selected by the skilled person depending on the size of the blank 10 and the diameter of the vacuum roller 3. After a blank has been released and blank 10 has been transferred to carriage 10 [sic: 20] of positioning system 2, pivot joint 30 [sic: 31] moves synchronously with vacuum roller 3 again until it reaches a transfer gap between vacuum roller 3 and positioning system 2 at approx. 6 o'clock in order to fix the next blank 10 to the transfer gap on the vacuum roller 3.

After a blank 10 has been picked up, the corresponding carriage 20 is moved along the circumferential track to transfer the blanks to the transfer line. In the exemplary embodiment shown, the carriages 20 are moved counterclockwise along the circumferential track designed as a circular track by approximately 180°.

As the movement towards the transfer line proceeds, the speed of the corresponding carriage 20 is changed for each blank 10 in such a way that the blank 10 picked up can be transferred to the transfer line in a precisely positioned manner, for example with respect to a product 12, and at a speed synchronized with the transfer line. When the blank is transferred to the transfer line, a vacuum applied to the suction surface of the product holder 22 is reduced so that the blanks 10 are released from the product holder 22.

In the exemplary embodiment shown, a sensor system 23 is provided for precise positioning of the blanks 10 at the transfer line. The sensor system 23 is configured to detect at least one position of the blank 10 on the product holder 22 in the direction of movement of the carriage 10 along the circumferential track.

In embodiments, the sensor system 23 is also configured to detect a position of the blank 10 on the product holder 22 transverse to the direction of movement and/or an orientation of the blank 10 on the product holder 22.

For correcting the position of the blank 10 transversely to the direction of movement and/or the orientation of the blank 10, an adjustment system 21 is provided in embodiments, which is schematically shown in FIG. 2 and which is designed to move the respective product holder 22 transversely to the direction of movement, as schematically indicated by arrows, before or during transfer of the blank, and/or to rotate it about an axis normal to the direction of movement. It is possible to detect the position and/or orientation of the blank 10 and make any necessary corrections individually for each blank 10. This enables the blanks to be transferred to the transfer line with great precision, preventing errors in advance.

For at least partial independent movement of the carriages 20, the drive system 24 in the exemplary embodiments shown in FIGS. 1 and 2 comprises so-called torque motors 240, wherein each carriage 20 is assigned a torque motor 240.

As can be seen most clearly in FIG. 2, the torque motors 240 shown comprise an outer stator ring 242 and an inner rotor ring 244. A mounting rail 26 is provided for mounting the torque motors 240, wherein the torque motors 240 are fastened to the mounting rail 26 in the longitudinal direction of the mounting rail 26 by means of stator holders 25. The carriages 20 with the position holders 22 are each attached to a rotor ring 244 so that the carriages 20 rotate with the associated rotor ring 244.

In the positioning system 2 shown in FIG. 2, pivot arms 200, by means of which the carriages 20 are connected to the respective rotor rings 244, are designed such that all carriages 20 run in a lane.

As shown schematically in FIG. 1, in embodiments, the mounting rail 26 is hollow so that it can be used as a media channel 5 for media guided in the schematically shown lines 50. Media channel 5 is used in particular to supply media such as electricity, data signals, compressed air, vacuum, or the like, wherein the media are required for moving the carriages 20 and/or the product holders 22 and/or for holding the blanks 10 on the product holders 22. The media, in particular electrical power and/or data signals, are connected to the carriages 20 in configurations via a slip ring arrangement 246 shown schematically in FIG. 1. Rotary feedthroughs are provided in embodiments for supplying the carriages 20 and/or the product holders 22 with vacuum and/or positive pressure. In certain designs, rotary unions and slip rings are integrated into common components.

In the exemplary embodiment shown in FIG. 1, the blanks 10 are produced on the vacuum roller 3 by means of the cooperating cutting roller 4.

However, this design is only an example. Depending on the area of application and product features, other designs are possible.

In a modified design, for example, the vacuum roller 3 is designed as a vacuum cutting roller which forms a cutting gap with a counter-punch cylinder to produce the blanks. A residual grid formed between the vacuum cutting roller and the counter-punching cylinder during punching is removed from the cutting gap by a pull-out device in certain designs. A corresponding design is particularly advantageous, but not exclusively so, for the manufacture of medical wound dressings.

In a further modified design, a material track that has already been cut is fed onto a carrier track of the vacuum roller 3. In other words, a carrier track with attached blanks is fed to the vacuum roller 3. In this case, the carrier track with the blanks 10 is placed on the vacuum roller 3 so that the blanks 10 are held on the vacuum roller by the vacuum applied. Instead of a cutting roller 4 as shown in FIG. 1, a delamination device is provided, by means of which the carrier track located on the outside of the blanks 10 is pulled off so that the blanks lie freely on the surface of the vacuum roller 3. This design is particularly, but not exclusively, advantageous for processing membranes such as those found in fuel cells, electrolysers, batteries, and membrane humidifiers.

With these designs, too, individual blanks are provided on a vacuum roller for transfer to the positioning system 2. However, it is also conceivable to provide the blanks 10 in a stationary supply, wherein the carriage 20 is brought to a standstill for transfer.

What is claimed is:

1. A device for transferring blanks to a transfer line, in particular for transferring blanks to a material track, a transport track, a rotating roller, and/or to products transported along a conveyor belt,
the device comprising a positioning system with at least two, in particular three or more, carriages movable along a circumferential track and with a drive system,
wherein the carriages each have a product holder and are designed to each pick up a blank on the product holder, to transport the blank in a stationary position on the product holder, and to transfer the blank to the transfer line, and
wherein the drive system is set up to move the carriages along the circumferential track at least in sections independently of each other.

2. The device according to claim 1, wherein the drive system is set up to individually adjust a speed of the associated carriage and/or a position of the associated carriage along the circumferential track for picking up and/or transferring each blank.

3. The device according to claim 1, wherein a sensor system is provided which is set up to detect a position and/or orientation of the blanks on the respective product holder.

4. The device according to claim 1, wherein the carriages each have an adjustment system which is designed to move the respective product holder before or during transfer to the transfer line, in particular transversely to a direction of movement along the circumferential track, and/or to rotate it, in particular about an axis normal to the direction of movement.

5. The device according to claim 1, wherein the product holders each comprise a porous and/or perforated suction surface which is connected to a vacuum source.

6. The device according to claim 1, wherein the carriages are movable, in particular by means of the drive system, along a circumferential track designed as a circular track around a central axis.

7. The device according to claim 1, wherein the drive system comprises several motors, each assigned to a carriage, in particular coaxially arranged torque motors, wherein the carriages are mounted on rotors of the torque motors.

8. The device according to claim 1, wherein a media channel is provided within the circumferential track, in particular coaxially with the central axis of the circumferential track designed as a circular track, wherein in particular the carriages and/or elements of the drive system are connected to the media channel for media transfer by means of a slip ring system.

9. The device according to claim 1, wherein the device comprises a vacuum roller, wherein the positioning system and the vacuum roller form a transfer gap and are arranged to transfer blanks from the vacuum roller to the positioning system in the region of the transfer gap, wherein, in particular, the vacuum roller comprises a pivot joint which is adjustable relative to the direction of rotation of the vacuum roller and via which a vacuum can be provided on a mantle surface of the vacuum roller.

10. A method for transferring blanks to a transfer line, in particular for transferring blanks to a material track, a transport track, a roller and/or to products transported along a conveyor belt, comprising providing a positioning system with at least two, in particular three or more, carriages movable along a circumferential track and each having a product holder, and picking up, transporting and transferring the blanks with the carriages of the positioning system having the product holders, wherein the carriages are moved along the circumferential track at least in sections independently of one another.

11. The method according to claim 10, wherein, for picking up and/or transferring each blank, a speed of the associated carriage and/or a position of the associated carriage along the circumferential track is individually adjusted.

12. The method according to claim 10, wherein a position and/or orientation of the blanks on the respective product holder is detected by a sensor.

13. The method according to claim 10, wherein, before or during transfer of at least one blank for changing a position and/or orientation of this blank on the associated carriage, the associated product holder is displaced transversely to a direction of movement along the circumferential track and/or rotated about a normal axis to the direction of movement.

14. The method according to claim 10, wherein the blanks are transferred from a vacuum roller to the carriages of the positioning system at a transfer gap.

15. The method according to claim 14, wherein the vacuum roller comprises a pivot joint that can be pivoted relative to the direction of rotation of the vacuum roller, via which a vacuum is provided on a mantle surface of the vacuum roller, wherein the pivot joint is pivoted in each case counter to a direction of rotation of the vacuum roller during transfer of the blanks, so that a vacuum in the region of the transfer gap is reduced or interrupted, wherein the pivot joint is pivoted back to an initial position with the vacuum roller, in particular after transfer.
